(19) United States
(12) Patent Application Publication
(10) Pub. No.: US 2015/0041652 A1
(43) Pub. Date: Feb. 12, 2015

(54) MATERIAL INSPECTION APPARATUS

(71) Applicant: KABUSHIKI KAISHA TOSHIBA, Tokyo (JP)

(72) Inventor: Haruko AKUTSU, Yokosuka-Shi (JP)

(73) Assignee: KABUSHIKI KAISHA TOSHIBA, Tokyo (JP)

(21) Appl. No.: 14/095,677

(22) Filed: Dec. 3, 2013

Related U.S. Application Data
(60) Provisional application No. 61/865,103, filed on Aug. 12, 2013.

(51) Int. Cl. G01N 23/22

(52) U.S. Cl. CPC G01N 23/22
USPC 250/336.1

(57) ABSTRACT

A material inspection apparatus according to the present embodiment includes a sample mount capable of mounting a sample. A detector detects an ion desorbed from the sample. A voltage generator applies a voltage to the sample. An optical system irradiates a laser beam onto the sample at a tilt angle with respect to a perpendicular direction to an end surface of a tip end of the sample. The tilt angle is equal to or smaller than a Brewster angle.

### CROSS REFERENCE TO RELATED APPLICATIONS

This application is based upon and claims the benefit of priority from the prior U.S. Provisional Patent Application No. 61/865,103 filed on Aug. 12, 2013, the entire contents of which are incorporated herein by reference.

### FIELD

The embodiments of the present invention relate to a material inspection apparatus.

### BACKGROUND

A laser-atom probe device applies a voltage to a sample and irradiates a laser beam onto the sample, thereby ionizing and field-evaporating atoms on a sample surface. The laser-atom probe device performs a material analysis on the sample at an atomic level by allowing a mass detector to detect the ions.

The sample to be analyzed by the laser-atom probe device is produced on a semiconductor substrate using, for example, an FIB (focused ion beam), etching, or dicing and processed into a needle-shaped sample. Such a needle-shaped sample is disadvantageously broken more easily during analysis when the curvature of a tip end of the needle-shaped sample is higher. Furthermore, when the sample is constituted by many materials and has a complicated structure, the sample is disadvantageously and easily broken by the laser-atom probe device.

### BRIEF DESCRIPTION OF THE DRAWINGS

FIG. 1 shows an example of a configuration of a laser atom probe according to a first embodiment;

FIG. 2 is an explanatory diagram showing an example of a configuration of the atom probe 100 and an operation performed by the atom probe 100 according to the first embodiment;

FIG. 3 is an explanatory diagram showing the tip end 104a of the sample 104 and the irradiation direction of the laser beam 114;

FIGS. 4A and 4B are graphs showing a relation between the incident angle θ of the laser beam 114 and a reflectance of the laser beam 114;

FIG. 5 is an explanatory diagram showing an example of a configuration of the optical system 115 of the atom probe 100 according to the first embodiment;

FIG. 6 is an explanatory diagram showing another example of the configuration of the optical system 115 of the atom probe 100 according to the first embodiment; and

FIG. 7 is an explanatory diagram showing still another example of the configuration of the optical system 115 of the atom probe 100 according to the first embodiment.

### DETAILED DESCRIPTION

Embodiments will now be explained with reference to the accompanying drawings. The present invention is not limited to the embodiments.

A material inspection apparatus according to the present embodiment includes a sample mount capable of mounting a sample. A detector detects an ion desorbed from the sample. A voltage generator applies a voltage to the sample. An optical system irradiates a laser beam onto the sample at a tilt angle with respect to a perpendicular direction to an end surface of a tip end of the sample. The tilt angle is equal to or smaller than a Brewster angle.

### First Embodiment

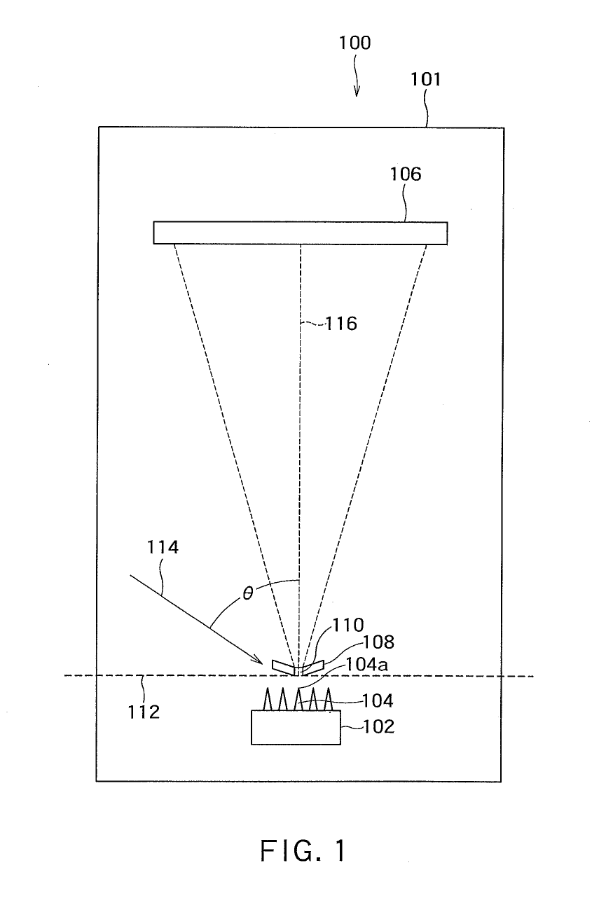

FIG. 1 shows an example of a configuration of a laser atom probe according to a first embodiment. An atom probe 100 includes a vacuum chamber 101, a sample mount 102, a mass detector 106, and an electrode 108.

The vacuum chamber 101 accommodates the sample mount 102, the mass detector 106, the electrode 108, and the like. The inside of the vacuum chamber 101 is vacuumed.

The sample mount 102 mounts thereon a sample 104, and applies a voltage to the sample 104. The voltage applied to the sample 104 can be set to a predetermined constant voltage or a pulsed boost voltage applied at each timing of desorption of ionized atoms from the sample 104. The sample 104 is produced on a semiconductor substrate using, for example, FIB (focused ion beam), etching, or dicing, and the sample 104 has a tip end 104a processed into a needle shape. For example, the sample 104 is produced in order to analyze and identify materials contained in a structure formed on the semiconductor substrate.

The mass detector 106 receives ions field-evaporated from the tip end 104a of the sample 104 so as to identify a mass-to-charge ratio of each of the ions or a relative position (a three dimensional position) of each of the atoms in the sample 104.

The electrode 108 is located between the sample mount 102 and the mass detector 106 and has an aperture 110 provided in a central portion thereof. The electrode 108 focuses an electric field on the vicinity of the tip end 104a of the sample 104 and thereby reduces energy necessary for a laser beam 114. The voltage of the electrode 108 can be set to a reference voltage (for example, a ground potential or an arbitrary fixed potential) or a pulsed voltage applied at each timing of the desorption of ionized atoms from the sample 104. Reference numeral 112 denotes an end surface of the tip end 104a of the sample 104. The end surface 112 is a surface perpendicular to a longitudinal direction (an extension direction) of the sample 104, that is, a surface of the tip end 104a of the sample 104. Furthermore, a perpendicular direction 116 is a direction perpendicular to the end surface 112 of the tip end 104a of the sample 104.

The sample mount 102 is movable so as to be able to position the tip end 104a of the sample 104. The sample mount 102 moves the sample 104 so that the tip end 104a of the sample 104 can be located on a central portion within the aperture 110 when viewed from a central portion of the mass detector 106.

It suffices that the laser beam 114 is emitted from an optical system arranged inside of the vacuum chamber 101 or introduced from an optical system arranged outside of the vacuum chamber 101 via an opening (a window) of the vacuum chamber 101. The laser beam 114 is irradiated onto the tip end 104a from a direction inclined at a certain angle θ with respect to the perpendicular direction 116 from the tip end 104a of the sample 104 to the mass detector 106. The perpendicular direction 116 can be rephrased as a longitudinal direction of the sample 104 or a direction pointed by the needle-shaped tip end 104a. According to need, the laser beam 114 can be oriented using a mirror, a collimator, a lens and/or another optical system, and can be focused on the tip end 104a. A pulsed laser beam applied at each timing of the desorption of the ionized atoms from the sample 104 can be used as the laser beam 114.

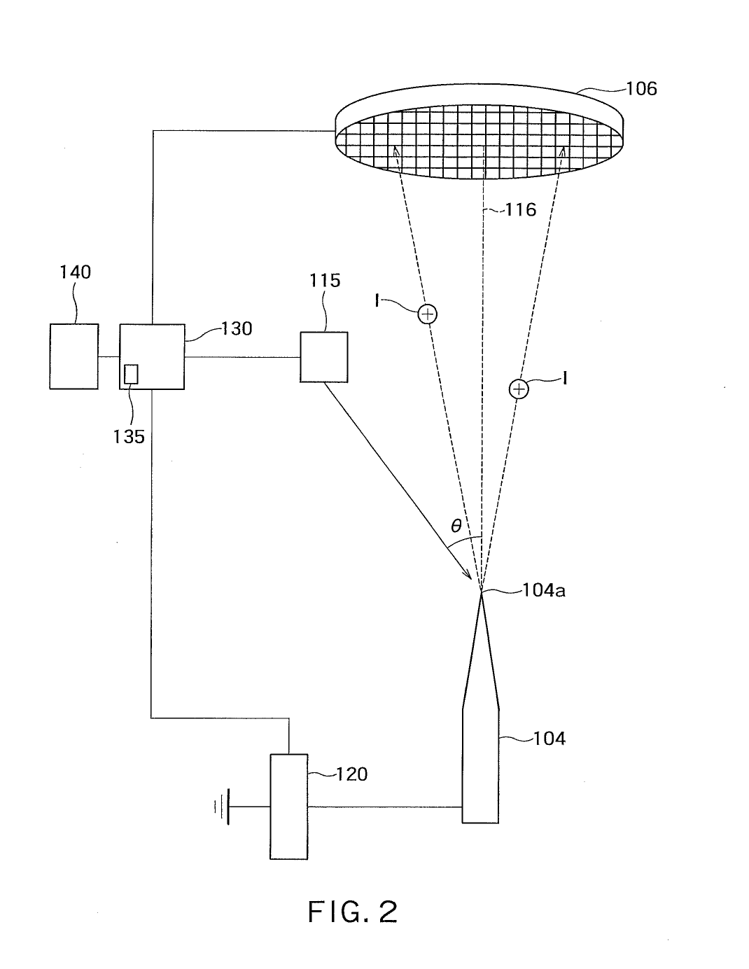

FIG. 2 is an explanatory diagram showing an example of a configuration of the atom probe 100 and an operation performed by the atom probe 100 according to the first embodiment. The atom probe 100 further includes an optical system 115, a voltage generator 120, an arithmetic control unit 130, and a memory 140.

In the first embodiment, the voltage generator 120 continuously applies a high voltage to the sample 104. The optical system 115 includes a laser generator and irradiates the pulsed laser beam 114 onto the tip end 104a of the sample 104 at a certain timing. Atoms on a surface of the tip end 104a are thereby ionized and field-evaporated. At this time, the atoms are desorbed in order from those on the surface of the tip end 104a. Ions I desorbed from the tip end 104a fly to the mass detector 106 by a high electric field generated by the high voltage applied by the voltage generator 120 and the reference voltage of the electrode 108 (see FIG. 1).

The arithmetic control unit 130 is constituted by using, for example, a CPU (Central Processing Unit). The arithmetic control unit 130 measures a flight time of each individual ion I from the time at which the laser beam 114 is irradiated until the mass detector 106 detects the ion I. The arithmetic control unit 130 includes a timer 135 so as to measure the flight time of the ion I. Furthermore, the mass detector 106 detects at which point in a plane of the mass detector 106 the ion I is detected.

The memory 140 stores therein programs for actuating the atom probe 100 and data such as the flight time of each ion I, and a position on the mass detector 106 detecting the ion I.

The flight time of the ion I is used to identify a mass-to-charge ratio of the ion I. The arithmetic control unit 130 can thereby identify the mass-to-charge ratio of the ion I. The arithmetic control unit 130 can also identify a type (element) of the ion I from the mass-to-charge ratio.

The position on the mass detector 106 detecting the ion I is used to identify a relative position of the ion I on the sample 104. The arithmetic control unit 130 can thereby identify the relative position (a planar position) of the ion I on the sample 104.

Furthermore, the atoms are desorbed in order from those present on a surface of the tip end 104a for every laser pulse and/or every voltage pulse. Therefore, by identifying the type (element) of the ion I for every laser pulse and/or every voltage pulse, the arithmetic control unit 130 can identify a relative depth of the ion I in the sample 104.

Because the planar position and the depth of the ion I on and in the sample 104 are identified, a three dimensional position of the ion I on the sample 104 is confirmed. The atom probe 100 can thereby three dimensionally detect what material (element) is present at what position on the tip end 104a of the sample 104.

The laser-atom probe device 100 has a problem that the tip end 104a of the sample 104 tends to be broken. The cause of this problem also lies in the structure of the needle-shaped sample 104 as already described. The inventor of the present embodiment paid attention to the angle θ formed between a traveling direction (a vector direction of a group velocity) of the laser beam 114 incident on the sample 104 and a direction pointed by the needle shape (a longitudinal direction) of the sample 104. The angle θ can be rephrased as a tilt angle with respect to the perpendicular direction 116 to the end surface 112 of the tip end 104a of the sample 104.

In a case of a conventional laser-atom probe device, the angle θ formed between the traveling direction of the laser beam 114 incident on the sample 104 and the direction pointed by the needle shape of the sample 104 is proximate to a right angle. This is because an optical system used to irradiate the laser beam 114 onto the tip end 104a of the sample 104 can be simplified. The simplified optical system facilitates the alignment of an optical axis of the optical system and the maintenance of the laser-atom probe device. Furthermore, a spot of the laser beam 114 is larger than the tip end 104a of the sample 104. Accordingly, by positioning of the laser beam 114 near the tip end 104a, the ions I are considered to be field-evaporated from the tip end 104a of the sample 104 without any difficulty even when the angle θ is proximate to the right angle.

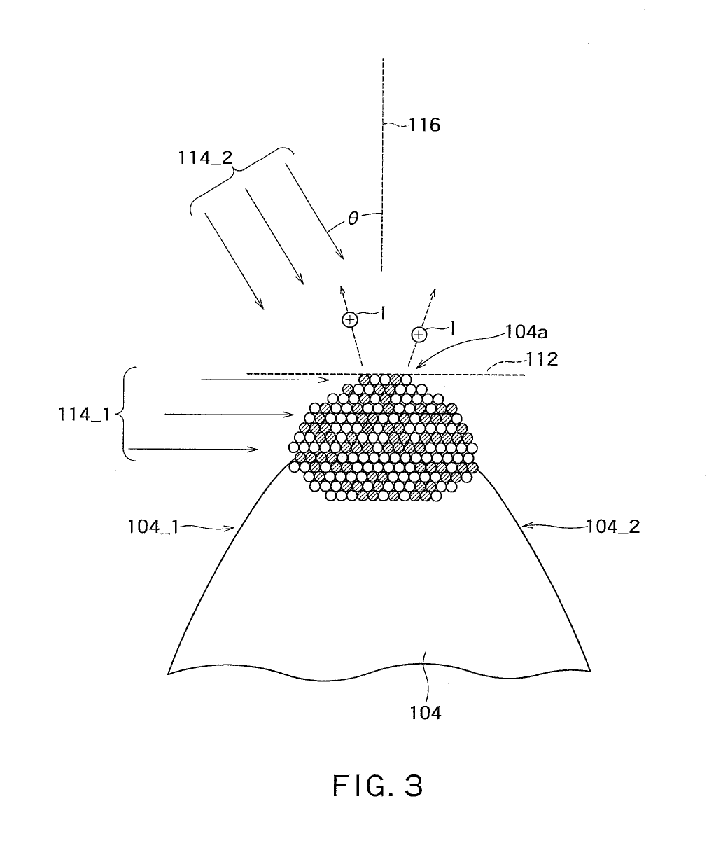

However, it is found that when the angle θ is proximate to the right angle, more ions I are field-evaporated from a surface (an irradiated surface) of the sample 104 onto which the laser beam 114 is irradiated and relatively fewer ions I are field-evaporated from a surface of the sample 104 opposite to the irradiated surface. That is, the ionization of atoms depends on an irradiation direction of the laser beam 114 and the atoms are ionized preferentially from the irradiated surface that absorbs much optical energy. For example, when the angle θ formed between the perpendicular direction 116 to the irradiated surface of the sample 104 (a direction pointed by the sample 104) and an incident direction of the laser beam 114 is substantially 90 degrees, most of the laser beam 114 is absorbed by one side of the sample 104. On the other hand, when the angle θ is substantially 0 degree, most of the laser beam 114 is absorbed by an end surface of the sample 104. Therefore, when the angle θ is substantially 0 degree, the atoms on the end surface tend to be field-evaporated. As shown in FIG. 3, the end surface of the sample 104 corresponds to a peak of the tip end 104a and peripheries thereof.

FIG. 3 is an explanatory diagram showing the tip end 104a of the sample 104 and the irradiation direction of the laser beam 114. In a case of laser beams 114_1 where the angle θ formed between the traveling direction of each laser beam 114_1 incident on the sample 104 and the perpendicular direction 116 (a direction pointed by the needle shape of the sample 104) is closer to 90 degrees, the optical energy of the laser beam 114_1 is introduced into the tip end 104a of the sample 104 non-uniformly. Therefore, atoms of the laser beam 114_1 near an irradiated surface 104_1 are easier to ionize whereas those near an unirradiated surface 104_2 are more difficult to ionize and tend to remain. This makes the shape of the sample 104 non-uniform and the tip end 104a of the sample 104 is easily damaged by stress or the like.

On the other hand, in a case of laser beams 114_2 where the angle θ formed between the traveling direction of each laser beam 114_2 incident on the sample 104 and the perpendicular direction 116 is an acute angle and relatively closer to 0 degree, the optical energy of the laser beam 114_2 is introduced into the tip end 104a of the sample 104 relatively uniformly. Therefore, the atoms on the surface of the tip end 104a of the sample 104 are easily field-evaporated in order. This can keep the shape of the tip end 104a of the sample 104 substantially uniform and make it difficult to break the sample 104. Making the sample 104 difficult to be broken contributes to improving analysis efficiency (shortening a turnaround time).

Next, the angle θ formed between the traveling direction of the laser beam 114 incident on the sample 104 and the perpendicular direction 116 is considered. Taking a reflectance (absorptivity) of the laser beam 114 into account, the laser beam 114 is absorbed by the tip end 104a of the sample 104 more easily when the angle θ is closer to 0 degree. Therefore, it is considered to be preferable that the angle θ is closer to 0 degree. However, it is necessary to avoid the interference of the optical system 115 with the flight of the ions I. Therefore, it is preferable that the angle θ has a certain range.

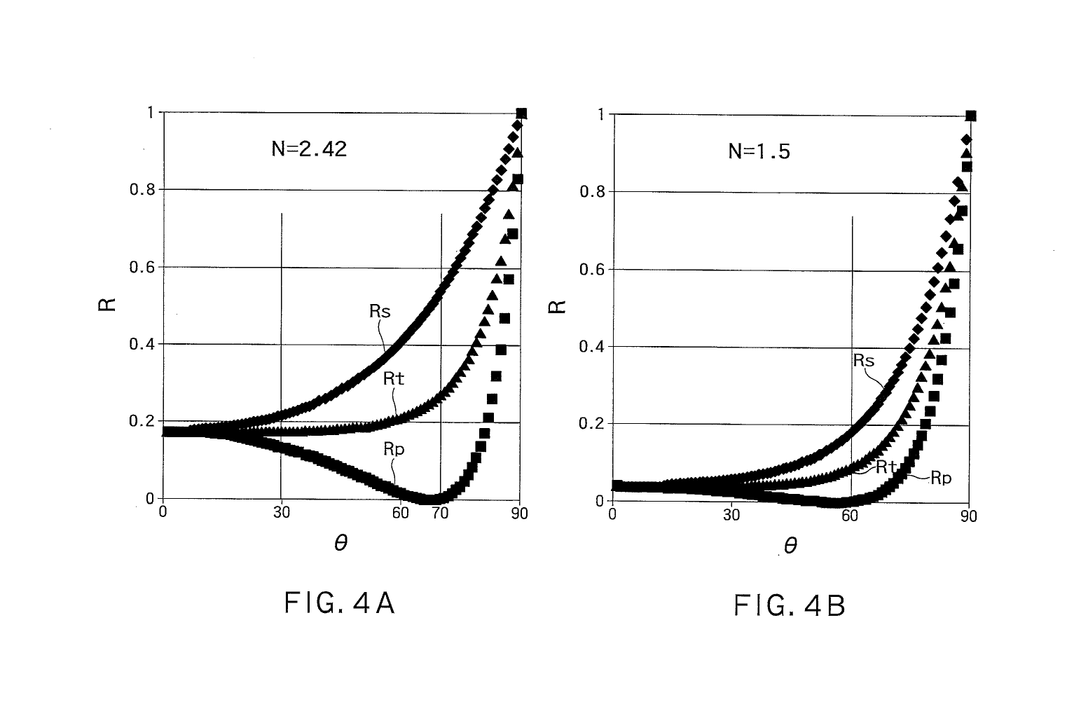

FIGS. 4A and 4B are graphs showing a relation between the incident angle θ of the laser beam 114 and a reflectance of the laser beam 114. FIG. 4A is a graph in a case of using diamond as the sample 104 and shows a reflectance in a vacuum atmosphere. A refraction index N of the diamond is 2.42. FIG. 4B is a graph in a case of using glass as the sample 104 and shows a reflectance in a vacuum atmosphere similarly to FIG. 4A. A refraction index N of the glass is 1.5. A reflectance Rs is a reflectance of s-polarized light (s-wave) of the laser beam 114 and a reflectance Rp is a reflectance of p-polarized light (p-wave) of the laser beam 114. A reflectance Rt is a total reflectance of the laser beam 114 obtained from the reflectance Rs and the reflectance Rp. The reflectance Rt can be expressed as (ratio of s-polarized light components)×Rs+(ratio of p-polarized light components)×Rp.

When the incident angle θ is equal to or larger than a so-called Brewster angle θb, the reflectance Rt greatly increases. The Brewster angle θb is expressed by the following Equation (1).

θb=Arctan(n2/n1) (Equation 1)

In Equation (1), n1 denotes a refraction index of an incidence-side material and n2 denotes a refraction index of a transmission-side material. In the first embodiment, n1 denotes a refraction index in a vacuum atmosphere and n2 denotes a refraction index of either the diamond or the glass.

In FIG. 4A, the Brewster angle θb of the diamond (an incident angle at which the Rp has a minimal value) is approximately 67.5 degrees. Therefore, when the incident angle θ of the laser beam 114 is equal to or smaller than approximately 70 degrees, the reflectance Rt of the laser beam 114 can be suppressed to be relatively low. However, when the incident angle θ of the laser beam 114 exceeds approximately 70 degrees, the reflectance Rt of the laser beam 114 greatly increases.

When the reflectance Rt is high, an amount of the laser beam 114 absorbed by the sample 104 decreases. That is, when the reflectance Rt is high, absorption efficiency with which the laser beam 114 is absorbed by the sample 104 declines. On the other hand, when the reflectance Rt is low, the amount of the laser beam 114 absorbed by the sample 104 increases. That is, when the reflectance Rt is low, the absorption efficiency with which the laser beam 114 is absorbed by the sample 104 rises.

Therefore, it is preferable to set the incident angle θ of the laser beam 114 to be equal to or smaller than approximately 70 degrees. With this configuration, the laser beam 114 can be efficiently absorbed by the end surface of the sample 104 and the atoms can be efficiently desorbed from the end surface of the sample 104.

Moreover, by setting the incident angle θ of the laser beam 114 to be equal to or smaller than approximately 70 degrees, the laser beam 114 is irradiated onto the end surface 112 of the tip end 104a of the sample 104 shown in FIG. 3. Therefore, the tip end 104a of the sample 104 does not become so non-uniform in shape and is less easily damaged. This contributes to improving analysis efficiency.

As shown in the graph of FIG. 4A, when the incident angle θ is equal to or smaller than approximately 30 degrees, the reflectance Rt is substantially constant to a minimum value. Therefore, it is more preferable to set the incident angle θ of the laser beam 114 to be equal to or smaller than approximately 30 degrees. With this configuration, the reflectance Rt of the laser beam 114 can be suppressed to be smaller and the laser beam 114 can be absorbed by the sample 104 with higher efficiency. By setting the incident angle θ of the laser beam 114 to be equal to or smaller than approximately 30 degrees, the incident direction of the laser beam 114 becomes closer to the perpendicular direction 116 shown in FIG. 3. Therefore, the laser beam 114 is irradiated onto the tip end 104a of the sample 104 and the tip end 104a of the sample 104 can be kept to have a substantially uniform shape (a shape bilaterally symmetric with respect to the longitudinal direction of the sample 104) during measurement. Thus, the sample 104 is less easily damaged.

In FIG. 4B, the Brewster angle θb of the glass is approximately 60 degrees. Therefore, when the incident angle of the laser beam 114 is equal to or smaller than approximately 60 degrees, the reflectance Rt of the laser beam 114 can be suppressed to be relatively low. However, when the incident angle θ of the laser beam 114 exceeds approximately 60 degrees, the reflectance Rt of the laser beam 114 greatly increases.

Therefore, it is preferable to set the incident angle θ of the laser beam 114 to be equal to or smaller than approximately 60 degrees in the case of glass. With this configuration, the laser beam 114 can be efficiently absorbed by the end surface of the sample 104 and the atoms can be efficiently desorbed from the end surface of the sample 104.

By setting the incident angle θ of the laser beam 114 to be equal to or smaller than about 60 degrees, the laser beam 114 is irradiated onto the end surface of the tip end 104a of the sample 104 shown in FIG. 3. Therefore, the tip end 104a of the sample 104 does not become so non-uniform in shape and is less easily broken. This contributes to improving analysis efficiency.

As described above, the laser-atom probe device 100 serving as the material inspection apparatus according to the first embodiment can improve the absorption efficiency with which the laser beam 114 is absorbed by the sample 104 and keep the shape of the tip end 104a of the sample 104 symmetrical by setting the incident angle θ of the laser beam 114 to be equal to or smaller than approximately 70 degrees. As a result, it is possible to suppress the damage of the sample 104 and to improve a measurement success rate.

Furthermore, because the incident angle θ of the laser beam 114 has a wide range from 0 to 70 degrees, the laser beam 114 can be irradiated onto the sample 104 without interference by the electrode 108 even when the electrode 108 is present near the tip end 104a of the sample 104 as shown in FIG. 1.

### (Configuration 1 of Optical System)

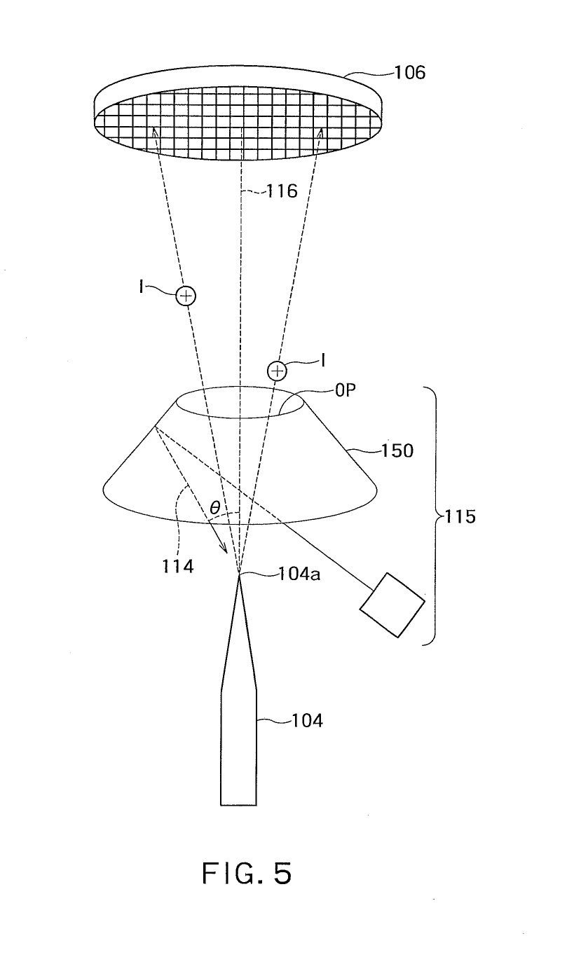

FIG. 5 is an explanatory diagram showing an example of a configuration of the optical system 115 of the atom probe 100 according to the first embodiment. The optical system 115 has an opening OP between the tip end 104a of the sample 104 and the mass detector 106 and includes the mirror 150 provided around the tip end 104a of the sample 104. A surface of the mirror 150 facing the sample 104 is a reflection surface. The laser beam 114 is reflected by the mirror 150 and irradiated onto the tip end 104a of the sample 104. Even with this configuration, it suffices to set the incident angle θ of the laser beam 114 finally irradiated onto the sample 104 to be equal to or smaller than approximately 70 degrees.

The mirror 150 is arranged between the sample 104 and the mass detector 106. However, because the opening OP is provided, the mirror 150 does not hinder the ions I desorbed from the sample 104 from flying to the mass detector 106.

In this way, the optical system 115 can indirectly irradiate the laser beam 114 onto the sample 104 using the reflection of the mirror 150 without directly irradiating the laser beam 114. Even with this configuration, effects of the first invention are not lost.

### (Configuration 2 of Optical System)

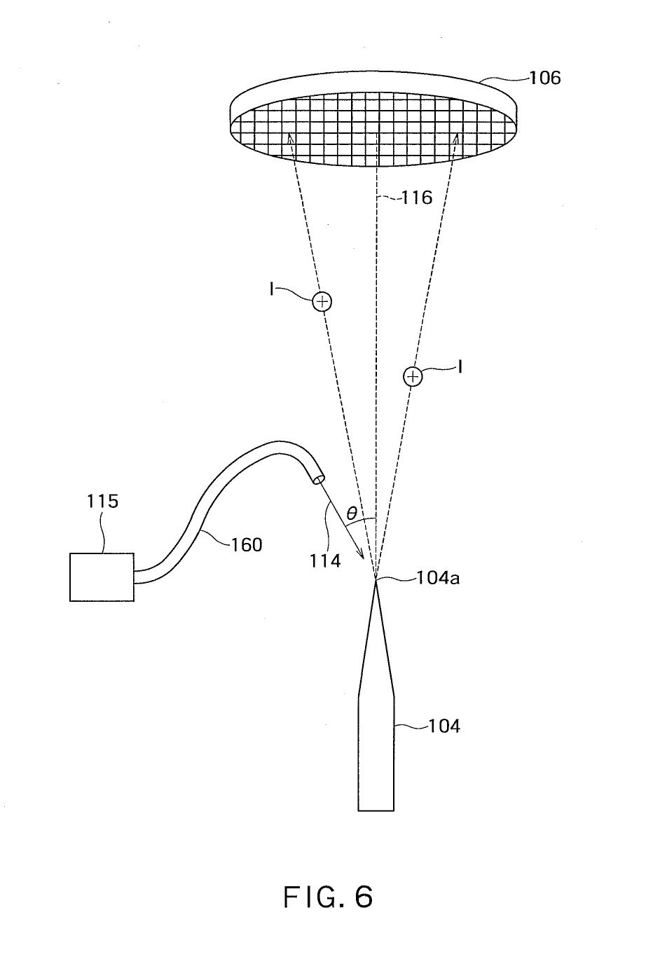

FIG. 6 is an explanatory diagram showing another example of the configuration of the optical system 115 of the atom probe 100 according to the first embodiment. The optical system 115 further includes an optical fiber 160 for guiding the laser beam 114 to the tip end 104a of the sample 104. The laser beam 114 is guided by the optical fiber 160 and irradiated onto the tip end 104a of the sample 104. At this time, the incident angle θ of the laser beam 114 finally irradiated onto the sample 104 is set to be equal to or smaller than approximately 70 degrees. The optical fiber 160 can be arranged so as not to hinder the ions I desorbed from the sample 104 from flying to the mass detector 106 because of high flexibility of arrangement. Even with this configuration, the effects of the first embodiment are not lost.

The configurations 1 and 2 of the optical system 115 can be combined. That is, the optical fiber 160 guides the laser beam 114 to the mirror 150. The mirror 150 can reflect the laser beam 114 from the optical fiber 160 and irradiate the laser beam 114 onto the tip end 104a of the sample 104. Even with this configuration, the effects of the first embodiment are not lost.

Furthermore, the optical system 115 can irradiate the laser beam 114 onto the sample 104 via a plurality of optical paths.

### (Configuration 3 of Optical System)

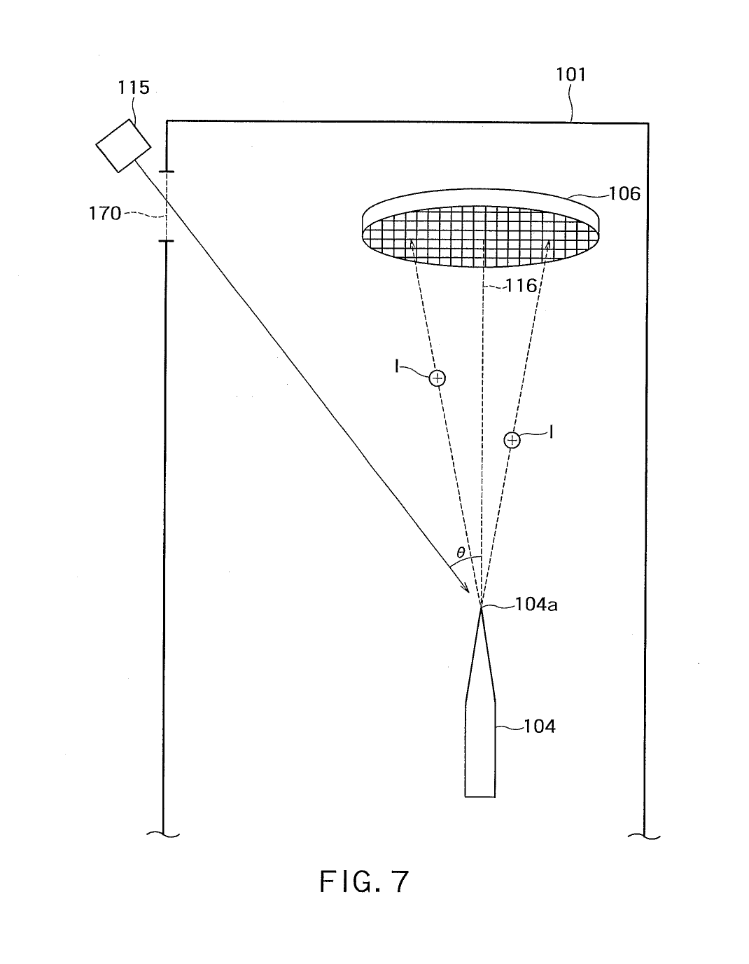

FIG. 7 is an explanatory diagram showing still another example of the configuration of the optical system 115 of the atom probe 100 according to the first embodiment. The optical system 115 is provided outside of the vacuum chamber 101 and irradiates the laser beam 114 onto the tip end 104a of the sample 104 via the window 170 provided on the vacuum chamber 101. At this time, the incident angle θ of the laser beam 114 finally irradiated onto the sample 104 is set to be equal to or smaller than approximately 70 degrees.

For example, the window 170 is provided in a direction inclined at an angle equal to or smaller than 70 degrees with respect to the perpendicular direction 116 when viewed from the tip end 104a of the sample 104. With this configuration, the laser beam 114 can be directly irradiated onto the sample 104 via the window 170. Even with this configuration, the effects of the first embodiment are not lost.

It is preferable to set the incident angle θ to be closer to 70 degrees so as to suppress the laser beam 114 from being reflected by the window 170. With this configuration, an angle at which the laser beam 114 is incident on the window 170 is also closer to the right angle, and it is difficult for the window 170 to reflect the laser beam 114.

Needless to mention, the laser beam 114 can be guided by still another optical system (for example, the mirror 150 or the optical fiber 160) and irradiated onto the sample 104 after entering through the window 170. That is, the configuration 3 can be combined with the configuration 1 and/or the configuration 2.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A material inspection apparatus comprising:
a sample mount capable of mounting a sample;
a detector detecting an ion desorbed from the sample;
a voltage generator applying a voltage to the sample; and
an optical system irradiating a laser beam onto the sample at a tilt angle with respect to a perpendicular direction to an end surface of a tip end of the sample, the tilt angle being equal to or smaller than a Brewster angle.

2. The apparatus of claim 1, wherein the optical system irradiates the laser beam onto the sample at a tilt angle equal to or smaller than 70 degrees with respect to the perpendicular direction to the end surface of the tip end of the sample.

3. The apparatus of claim 1, wherein the optical system irradiates the laser beam onto the sample at a tilt angle equal to or smaller than 70 degrees with respect to a longitudinal direction of the sample.

4. The apparatus of claim 1, wherein
the optical system comprises an opening between the tip end of the sample and the detector, and comprises a mirror provided around the tip end of the sample, and
the laser beam is reflected by the mirror and irradiated onto the tip end of the sample.

5. The apparatus of claim 2, wherein
the optical system comprises an opening between the tip end of the sample and the detector, and comprises a mirror provided around the tip end of the sample, and
the laser beam is reflected by the mirror and irradiated onto the tip end of the sample.

6. The apparatus of claim 4, wherein the mirror is arranged between the sample and the detector.

7. The apparatus of claim 5, wherein the mirror is arranged between the sample and the detector.

8. The apparatus of claim 1, wherein the sample mount, the detector, the voltage generator, and the optical system are arranged within a vacuum chamber.

9. The apparatus of claim 1, wherein the optical system comprises an optical fiber guides the laser beam.

10. The apparatus of claim 4, wherein
the optical system comprises an optical fiber guiding the laser beam, and
the mirror reflects the laser beam from the optical fiber and irradiates the laser beam onto the tip end of the sample.

11. The apparatus of claim 5, wherein
the optical system comprises an optical fiber guiding the laser beam, and
the mirror reflects the laser beam from the optical fiber and irradiates the laser beam onto the tip end of the sample.

12. The apparatus of claim 1, wherein the optical system irradiates the laser beam via a plurality of optical paths.

13. The apparatus of claim 8, wherein
the vacuum chamber comprises a window guiding the laser beam, and
the window is provided in a direction of an angle equal to or smaller than 70 degrees with respect to the perpendicular direction to the end surface of the tip end of the sample.

14. The apparatus of claim 13, wherein the laser beam is directly irradiated onto the sample via the window.

15. The apparatus of claim 1, wherein the optical system irradiates the laser beam onto the sample at a tilt angle equal to or smaller than 60 degrees with respect to the perpendicular direction to the end surface of the end portion tip end of the sample.

16. The apparatus of claim 1, wherein the optical system irradiates the laser beam onto the sample at a tilt angle equal to or smaller than 30 degrees with respect to the perpendicular direction to the end surface of the end portion tip end of the sample.
